(19) United States
(12) Patent Application Publication
(10) Pub. No.: US 2024/0054287 A1
(43) Pub. Date: Feb. 15, 2024

(54) CONCURRENT LABELING OF SEQUENCES OF WORDS AND INDIVIDUAL WORDS

(71) Applicant: Microsoft Technology Licensing, LLC, Redmond, WA (US)

(72) Inventors: Yinheng LI, Redmond, WA (US); Kebei JIANG, Houston, TX (US)

(21) Appl. No.: 17/886,440

(22) Filed: Aug. 11, 2022

(51) Int. Cl. G06F 40/284; G06F 40/289; G06F 16/35; G06V 30/414; G06F 16/338

(52) U.S. Cl. CPC G06F 40/284; G06F 40/289; G06F 16/353; G06V 30/414; G06F 16/338

(57) ABSTRACT

A computing system includes a processor and memory that stores instructions that, when executed by the processor, cause the processor to perform several acts. The acts include providing tokens as input to a computer-implemented model, where the tokens are representative of a sequence of words, and further where the computer-implemented model has been trained to identify sets of tokens that pertain to a topic and individual tokens within the sets of tokens that pertain to the topic. The acts also include obtaining, from the computer-implemented model: 1) a first label assigned to a token within the tokens by the computer-implemented model, where the first label indicates that a word represented by the token pertains to the topic; and 2) a second label assigned collectively to the tokens by the computer-implemented model, where the second label indicates that the sequence of words represented by the tokens collectively pertains to the topic.

### BACKGROUND

Computer-implemented text classification refers to machine learning techniques that assign predefined categories (labels) to unstructured text. Computer-implemented text classification technologies can be employed to organize, structure, and categorize nearly any type of text, including unstructured text extracted from web pages, medical studies, and so forth. In a specific example, computer-implemented text classification technologies can be employed to assign topics to news articles, such that the news articles can be organized by topic.

Named entity recognition (NER) is an example text classification technology, where NER technologies locate and classify named entities mentioned in unstructured text into predefined categories such as person names, organizations, locations, and so forth. In operation, a computer-implemented NER system receives a block of unstructured text (such as a sentence) and identifies words in the unstructured text that refer to a named entity of a particular type, such as a name of a person. Conventional NER systems are fairly accurate, at least partially because the NER systems can leverage a pre-existing dictionary of known named entities. For example, a computer-implemented NER system that detects names of people can use a dictionary of known person names to identify those names in unstructured text.

When, however, conventional NER technologies are utilized to classify unstructured text in connection with identifying words that pertain to a topic, the NER technologies may be somewhat inaccurate. In an example, a conventional NER system is developed to identify words in unstructured text that pertain to environmentally friendly technologies. There is, however, significant variability in vocabulary used by environmentalists (and others) to describe environmentally friendly technologies. Therefore, the NER system is unable to leverage a predefined dictionary in connection with identifying words that pertain to environmentally friendly technologies, resulting in the NER system failing to identify words that pertain to such topic and/or incorrectly labeling a word as pertaining to the topic.

While the example above refers to environmentally friendly technologies, conventional NER technologies are not well suited to identify words that pertain to scientific topics included in scientific text. In a specific example, conventional NER systems are unable to accurately identify hydrocarbon indicators in scientific text at least partially due to the lack of a standardized vocabulary (and thus lack of a dictionary of hydrocarbon indicators).

### SUMMARY

The following is a brief summary of subject matter that is described in greater detail herein. This summary is not intended to be limiting as to the scope of the claims.

Described herein are various technologies pertaining generally to text classification, and more specifically to identifying words in unstructured text that pertain to a topic. With more specificity, a computer-implemented text classification system is described herein, where the text classification system includes a computer-implemented model that simultaneously 1) identifies words in the unstructured text that pertain to the topic; and 2) identifies sequences of words (e.g., paragraphs, sentences, phrases, etc.) that include words that pertain to the topic. This approach is in contrast to approaches employed in conventional technologies, as in conventional approaches computer-implemented models only perform one of the two tasks referenced below—either identify words in unstructured text that pertain to the topic or identify sequences of words in unstructured text that pertain to the topic. The computer-implemented text classification system has been observed to have improved accuracy when compared to conventional text classification systems, particularly with respect to scientific topics, due at least partially to the computer-implemented model being trained to simultaneously perform the two classification tasks referenced above. The computer-implemented text classification system described herein is particularly well-suited to identify words that pertain to scientific topics. For instance, the computer-implemented text classification system is particularly well-suited to identify hydrocarbon indicators in unstructured text.

The computer-implemented model is trained based upon labeled data, where words in the labeled data are labeled to indicate that the words pertain to a topic for which the computer-implemented model is to be trained. The labeled data is subject to preprocessing such that sequences of words can be extracted from the labeled data. For example, preprocessing of the labeled data includes identifying sentence boundaries based upon, for example, punctuation in the labeled data (periods, capitalizations, etc.) and/or parts of speech identified by way of natural language processing (NLP). Sentences can then be extracted from the labeled data based upon the identified sentence boundaries. An extracted sequence of words is then assigned a label based upon whether at least one word in the sequence of words is labeled as pertaining to the topic. Hence, the labeled data is updated such that the labeled data not only includes the label(s) assigned to the at least one word in the sequence of words but also includes the label assigned to the sequence of words.

The computer-implemented model is trained based upon this labeled data, such that the computer-implemented model, when trained, is configured to receive a sequence of words and assign a label to a word in the sequence of words that indicates that the word pertains to the topic. The computer-implemented model, when trained, is further configured to assign a second label to the sequence of words to indicate that the sequence of words includes at least one word that pertains to the topic. A computer-readable index can be updated based upon labels assigned to words and labels assigned to sequences of words. In a non-limiting example, the topic can be hydrocarbon indicators, such that words identified in unstructured text as being hydrocarbon indicators are labeled as such in the index, and the index further identifies sequences of words (e.g., sentences or paragraphs) that include hydrocarbon indicators.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing system that is configured to identify words in unstructured text that pertain to a topic.

FIG. 2 depicts unstructured text, where words in the unstructured text have been identified as hydrocarbon indicators.

FIG. 3 is a functional block diagram of a computing system that is configured to train a computer-implemented model to identify words that pertain to a topic and to further identify sequences of words that include words that pertain to the topic.

FIG. 4 is a schematic that illustrates assignment of a label to a sequence of words in unstructured text to update training data.

FIG. 5 is a functional block diagram of a computing system that is configured to rank search results based upon labels assigned to words in unstructured text.

FIG. 6 is a flow diagram that illustrates a methodology for updating a computer-readable index based upon a first label assigned to a word in unstructured text and a second label assigned to a sequence of words in the unstructured text.

FIG. 7 is a flow diagram that illustrates a methodology for training a computer-implemented model based upon training data such that the computer-implemented model concurrently labels individual words and sequences of words upon being provided with sequences of words of unstructured text.

FIG. 8 is a flow diagram illustrating a methodology for returning search results based upon labels assigned to words and sequences of words in unstructured text.

FIG. 9 depicts a computing system.

### DETAILED DESCRIPTION

Various technologies pertaining to computer-implemented text classification are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, and “system” are intended to encompass computer-readable data storage that is configured with computer-executable instructions that cause certain functionality to be performed when executed by a processor. The computer-executable instructions may include a routine, a function, or the like. It is also to be understood that a component, module, or system may be localized on a single device or distributed across several devices. Further, as used herein, the term “exemplary” is intended to mean serving as an illustration or example of something and is not intended to indicate a preference.

Described herein are various technologies pertaining to identifying words in unstructured text that pertain to a topic. In a specific example, the technologies described herein pertain to identifying words in unstructured text that pertain to a scientific topic. In yet a still more specific example, the technologies described herein pertain to identifying words in unstructured scientific text that are hydrocarbon indicators. In another example, the technologies described herein pertain to identifying words in unstructured text that pertain to a medical topic (e.g., the unstructured text can be extracted from text entry fields of an electronic health records application, from medical articles, etc.).

In operation, a computing system receives a sequence of words, such as a sentence, a paragraph, a phrase, or the like. The sequence of words can be extracted from a webpage, an electronic document, etc. The sequence of words is transformed into a sequence of tokens through use of a suitable tokenizer. A token is a numerical representation of a word or subword. The sequence of tokens is provided to a computer-implemented model, where the computer-implemented model can be a deep neural network (DNN). In a more specific example, the computer-implemented model is a DNN that includes bidirectional transformer encoders.

The computer-implemented model receives the sequence of tokens as input thereto. The computer-implemented model then determines, for each token in the sequence of tokens, whether the token represents a word or subword that pertains to a topic with respect to which the computer-implemented model has been trained. The computer-implemented model additionally and concurrently determines whether the sequence of tokens collectively pertains to the topic. Therefore, in an example, the computer implemented model receives the sequence of tokens and outputs a first label for a token in the sequence of tokens and a second label for the sequence of tokens collectively, where the first label indicates that a word or subword represented by the token pertains to the topic and the second label indicates that the sequence of words represented by the sequence of tokens pertains to the topic. This is in contrast to conventional approaches used to identify words in unstructured text that pertain to a topic. Specifically, conventionally, a computer-implemented model for performing text classification is trained to perform one of the two classification tasks referenced above: identifying individual words that pertain to a topic or identifying sequences of words that pertain to the topic. It has been observed that the computer-implemented model that is trained to concurrently perform both of the classification tasks reference above exhibits improved performance over computer-implemented models that are trained to perform one of the two classification tasks. Specifically, a computer-implemented model trained to concurrently identify words that are hydrocarbon indicators and sentences that include hydrocarbon indicators was observed to more accurately identify hydrocarbon indicators when compared to conventional named entity recognition (NER) technologies.

The computing system assigns the appropriate labels to the words and sequences of words in the unstructured text based upon the labels assigned to the tokens and the sequences of tokens by the computer-implemented model. A computer-readable index can be updated based upon the labels assigned to the words and the sequences of words, such that the words that pertain to the topic, the sequences of words that pertain to the topic, and/or documents that include the sequences of words that pertain to the topic are indexed by the topic in the computer-readable index. A search system can identify words, sequences of words, and/or documents based upon content of the computer-readable index. In another example, snippets that are descriptive of documents can be generated based upon the labels assigned to the words and/or sequences of words. In still yet another example, documents can be ranked in a ranked list of documents based upon the labels assigned to the words and/or sequences of words.

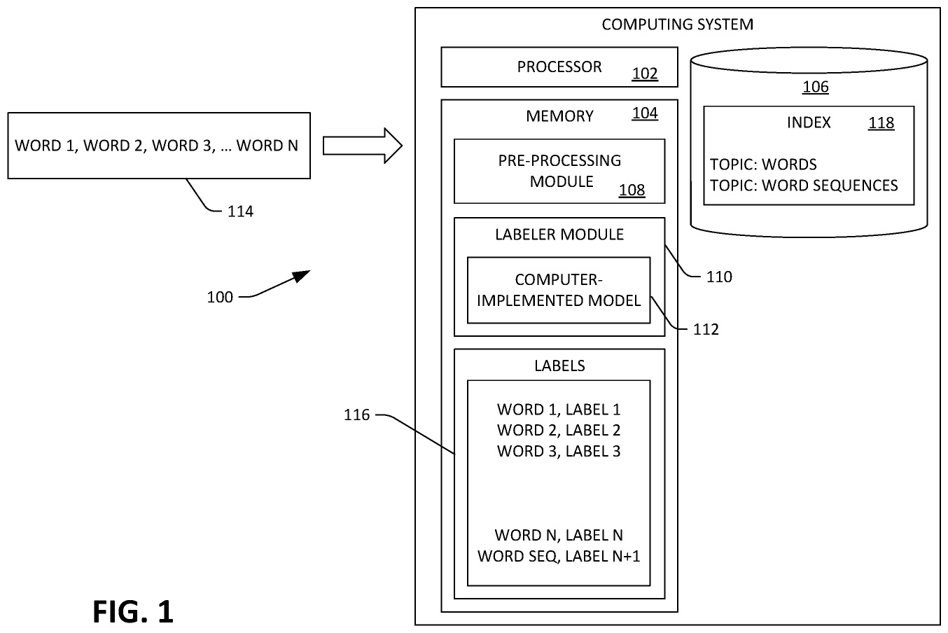

With reference now to FIG. 1, a computing system 100 that identifies words and sequences of words that pertain to a (specific) topic is illustrated. The computing system 100 includes a processor 102, memory 104, and a data store 106. The memory 104 includes modules that are executed by the processor 102. More specifically, the memory 104 includes a text classification system, where the text classification system includes a preprocessing module 108 and a labeler module 110, where the labeler module 110 includes a computer-implemented model 112. The computer-implemented model 112 can be a deep neural network (DNN), such as a recurrent neural network (RNN), a convolutional neural network (CNN), or the like. In an example, the computer-implemented model 112 is a DNN that includes bidirectional transformer encoders, such as the Bidirectional Encoder Representations from Transformers (BERT) model. As will be described in greater detail below, the computer-implemented model 112 is trained to concurrently 1) determine that a sequence of words pertains to a topic; and 2) identify individual words in the sequence of words that pertain to the topic.

In operation, the computing system 100 receives unstructured text 114, where the unstructured text 114 can be extracted from HTML of a web page, can be extracted from electronic word processing documents (e.g., scientific documents from a library of documents), etc. The unstructured text 114 includes a sequence of words (word 1, word 2, through word N). A sequence of words may be an entirety of the unstructured text 114, a paragraph in the unstructured text, a sentence in the unstructured text, or a phrase in the unstructured text. The preprocessing module 108 receives the unstructured text 114 and extracts the sequence of words from the unstructured text 114. For example, the preprocessing module 108 identifies sentence boundaries in the unstructured text 114 based upon punctuation in the unstructured text 114 and whitespaces in the unstructured text 114. The preprocessing module 108 can extract a sentence from the unstructured text based upon the identified sentence boundaries. Optionally, the preprocessing module 108 parses the unstructured text 114, assigns syntactic labels to words in the unstructured text 114, and identifies the sentence boundaries based upon the syntactic labels.

In another example, the preprocessing module 108 identifies paragraph boundaries in the unstructured text 114 and extracts a paragraph from the unstructured text based upon the identified paragraph boundaries (where the preprocessing module 108 can identify the paragraph boundaries based upon line breaks in the unstructured text 114). In yet another example, the preprocessing module 108 can utilize natural language processing (NLP) technologies to extract a phrase from the unstructured text 114, where the phrase is of a desired type (e.g., a noun phrase, an adjective phrase, etc.).

The labeler module 110 receives the sequence of words as input thereto. The labeler module 110 tokenizes the sequence of words to generate a sequence of tokens, where a token is a numeric and semantic representation of a word or subword (and can further represent position of the word or subword in the sequence of words). The labeler module 110 can employ any suitable tokenizing technologies to tokenize the sequence of words, thereby forming the sequence of tokens. For example, the labeler module 110 can employ a dictionary that maps words and/or subwords to tokens when tokenizing the sequence of words.

The computer-implemented model 112 receives the sequence of tokens and assigns a label to the sequence of tokens while simultaneously assigning labels to tokens in the sequence of tokens individually. For example, the computer-implemented model 112 is a binary classifier, where a label assigned to a token is indicative of whether or not the token represents a word or subword that pertains to a topic with respect to which the model 112 has been trained. Similarly, a label assigned to the sequence of tokens is indicative of whether or not the sequence of words pertains to the topic. The topic can be any suitable topic for which the computer-implemented model 112 has been trained. Thus, the topic may be “sports”, “finance”, “automobiles”, and so forth. In a more specific example, the topic can be scientific in nature, such as a particular field of science (refineries, chemical manufacturing, environmental sciences, etc.). In a still more specific example, the topic can be hydrocarbon indicators, such that a label assigned to a token indicates that a word or subword represented by the token pertains to a hydrocarbon indicator, and a label assigned to a sequence of tokens indicates that the sequence of words includes a hydrocarbon indicator.

As can be ascertained from the foregoing, the computer-implemented model 112 assigns a label to the sequence of tokens (collectively) and assigns labels to the respective tokens in the sequence of tokens. The labeler module 110 can assign such labels to the sequence of words extracted from the unstructured text 114 and the individual words in such sequence of words. The labeler module 110 outputs labels 116, where the labels 116 include labels assigned to respective words in the sequence of words and a label that is assigned to the entirety of the sequence of words.

The data store 108 includes a computer-readable index 118, where the index 118 can include individual words that are indexed by the topic as well as sequences of words that are indexed by the topic. The computing system 100 can update the index 118 based upon the labels 116 output by the labeler module 110. In an example, when the computer-implemented model 112 is trained to identify hydrocarbon indicators, a searcher can search over the index 118 to identify words that are hydrocarbon indicators, sequences of words that include hydrocarbon indicators, documents that include hydrocarbon indicators, and so forth.

As noted several times above, the computer-implemented model 112 concurrently assigns a label to a sequence of words and labels to words within the sequence of words. A sequence of words can be a paragraph, a sentence, a phrase, etc. Further, the computer-implemented model 112 can concurrently assign labels to a paragraph, sentences in the paragraph, and words in the sentences (and thus the computer-implemented model can perform paragraph classification, sentence classification, and word classification. In an example, a paragraph includes a first sentence and a second sentence, the first sentence includes 5 words, and the second sentence includes 10 words. The labeler module 110 can receive the paragraph as input, and output 15 labels for the 15 words in the paragraph, two labels for the two sentences in the paragraph, and one label for the paragraph. Other approaches are also contemplated.

As indicated previously, the computer-implemented model 112 exhibits improved performance relative to computer implemented models that are trained to perform a single classification task (e.g., word classification or sentence classification, but not both). In other words, the computer-implemented model 112 is better able to identify words that pertain to a topic when compared to conventional models, particularly when the topic is scientific in nature.

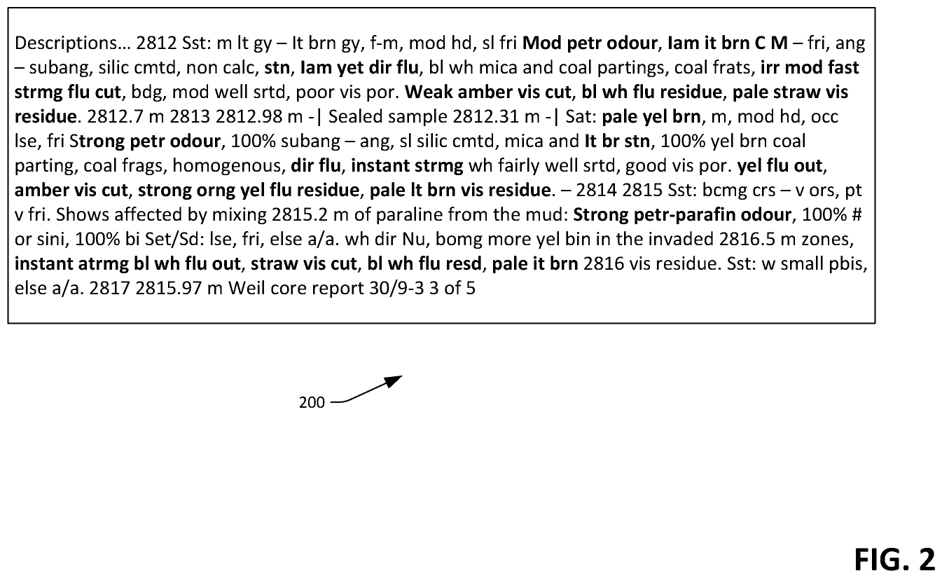

FIG. 2 illustrates unstructured text 200 from a scientific domain. As can be ascertained, the unstructured text 200 includes words that are uncommon, includes abbreviations that are not standard, etc. The unstructured text 200 includes numerous hydrocarbon indicators, and the computer-implemented model 112 can be trained to identify the hydrocarbon indicators in the unstructured text 200. Conventional approaches, and specifically named entity recognition (NER) technologies, are not well suited for identifying the hydrocarbon indicators in the unstructured text 200 due to the lack of a dictionary that explicitly defines such indicators and their typical abbreviations. The technologies described herein, however, can be employed to relatively accurately identify the hydrocarbon indicators (shown in bold in the unstructured text 200).

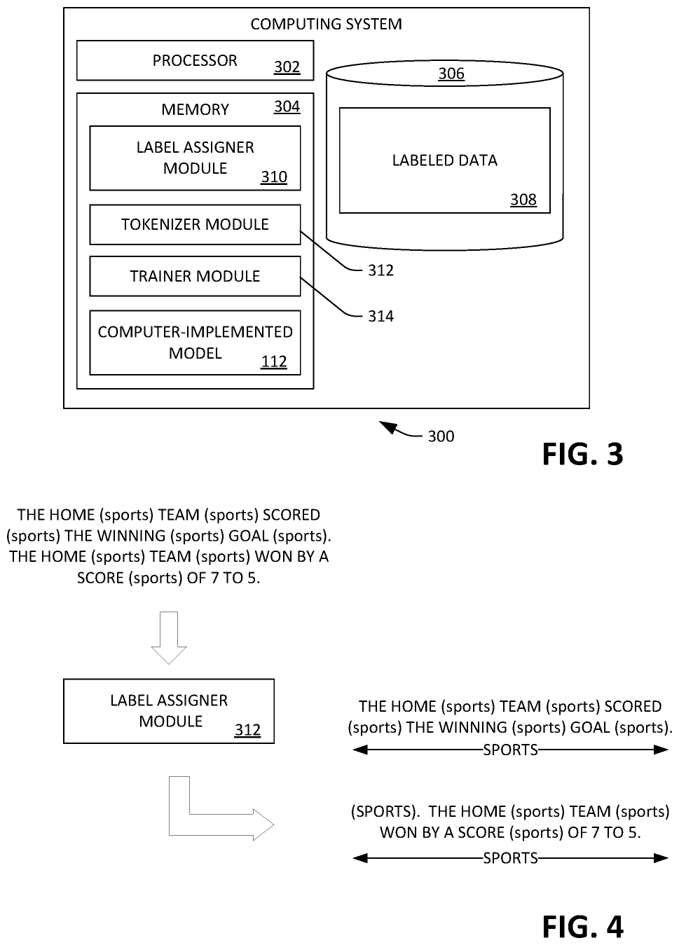

Now referring to FIG. 3, a functional block diagram of a computing system 300 that is configured to train the computer-implemented model 112 is illustrated. The computing system 300 includes a processor 302, memory 304, and a data store 306. The memory 304 includes modules that are executed by the processor 302 and the data store 306 includes labeled data 308, where the computer-implemented model 112 is trained based upon the labeled data 308. The labeled data 308 includes unstructured text, where words in the unstructured text that pertain to a topic are labeled to indicate that such words pertain to the topic. For instance, the labeled data 308 can include unstructured text that comprises hydrocarbon indicators, and words in the unstructured text that are hydrocarbon indicators can be (manually) labeled to indicate that the words are hydrocarbon indicators.

The memory 304 includes a label assigner module 310, a tokenizer module 312, a trainer module 314, and the computer implemented model 112. The label assigner module 310 obtains the labeled data 308 and identifies boundaries of sequences of words in the labeled data 308. For example, the label assigner module 312 identifies boundaries of sentences in the labeled data 308. As noted above, the labeled data 308 includes labels that are assigned to words that pertain to the topic with respect to which the computer-implemented model 112 is to be trained. The label assigner module 312 assigns labels to sequences of words based upon whether there are any words in the sequence of words that have a label assigned thereto.

Referring briefly to FIG. 4, a schematic that illustrates operation of the label assigner module 312 is presented. In the example shown in FIG. 4, the labeled data 308 includes the sentence “the home team scored the winning goal.” In such sentence, the words “home” “team” “scored” “winning” and “goal” are assigned a label that indicates that such words pertain to the topic of “sports”. Because the sentence includes a word that is labeled as pertaining to the topic “sports”, the label assigner module 312 assigns a label to an entirety of these sentence to indicate that the sentence pertains to the topic “sports.” Thus, when the label assigner module 312 receives a sentence, the label assigner module assigns a label to the sentence when a word in the sentence is labeled as pertaining to the topic.

Returning to FIG. 3, the tokenizer module 312 tokenizes the words in the sequences of words extracted from the labeled data 308. The trainer module 314 trains the computer-implemented model 112 based upon the tokens output by the tokenizer module 312 and the labels respectively assigned to the tokens and sequences of tokens. More specifically, as described above, the tokenizer module 312 can transform a sequence of words, such as a sentence, into a sequence of tokens, where a token represents a word or a sub word in the sentence. Labels assigned to the words in the sentence can be assigned to the tokens either by the tokenizer module 312 or the trainer module 314. In addition, the label assigned to the sentence by the label assigner module 310 is assigned collectively to the sequence of tokens. Therefore, the trainer module 314 is provided with numerous sequences of tokens and appropriate labels assigned thereto. The trainer module 314 trains the computer-implemented model 112 based upon the sequences of tokens, labels assigned to the sequences of tokens, and labels assigned to individual tokens within the sequences of tokens. Once trained, the computer implemented model 112 can operate as described above, receiving a sequence of tokens and assigning a label collectively to the sequence of tokens and labels to individual tokens within the sequence of tokens.

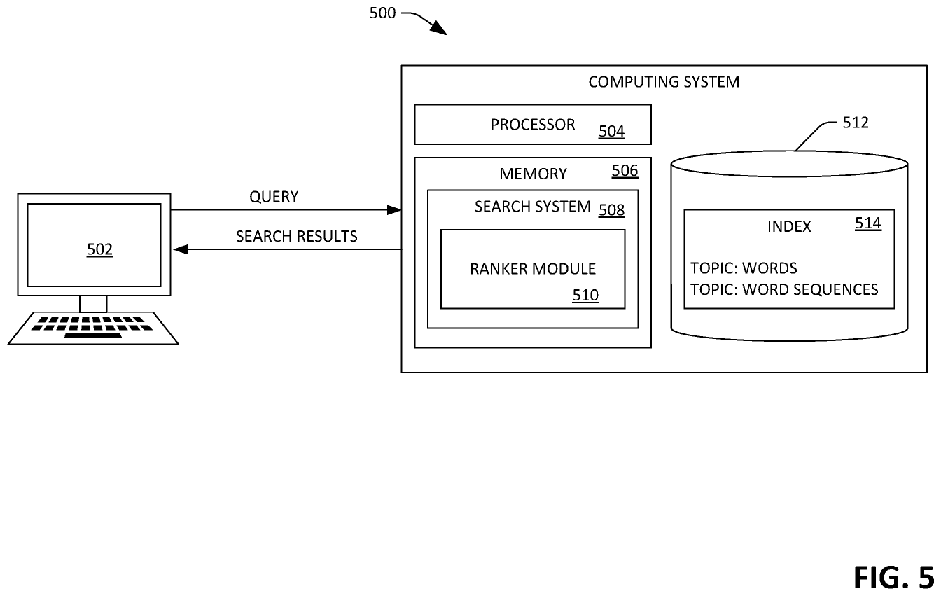

With reference now to FIG. 5, a computing system 500 that is configured to return search results to a user based upon a query is illustrated. The computing system 500 is in communication with a client computing device 502 by way of a network, such as the Internet. The computing system 500 includes a processor 504 and memory 506, where the memory 506 has a search system 508 loaded therein that is executed by the processor 504. The search system 508 includes a ranker module 510 that is configured to rank search results identified by the search system 508 based upon values of features of the search results and/or values of features of a query used by the search system 508 to identify these search results.

The computing system 500 further includes a data store 512, where the data store 512 includes the computer-readable index 118. As noted above, the index 118 includes words, word sequences, and/or documents that include the word sequences, where the words, word sequences, and/or documents are indexed by the topic with respect to which the computer-implemented model 112 was trained.

The search system 508 receives a query from the client computing device 502. The search system 508 searches the index 118 based upon the query and identifies search results that are indexed in the index 118. The search results may be one or more of the words, one or more of the word sequences, one or more documents that include the word sequences, etc. The ranker module 510 can rank the search results based upon values of features of the search results. In an example, the ranker module 510 can rank a word, word sequence, and/or document based upon the word, word sequence, and/or document being indexed by the topic in the index 118. For instance, the ranker module 510 can ascertain that the received query pertains to the topic and can rank a first search result above a second search result due to the first search result being assigned a label that indicates that the first search result pertains to the topic while the second search result fails to include such a label.

Hence, a word, word sequence, and/or document can be ranked amongst a ranked list of documents based upon a label assigned to the word, word sequence, and/or document by the computer-implemented model 112. In another example, a snippet can be generated based upon a document being assigned a label. For instance, when a document is a scientific document and includes terms having a particular categorization (such as hydrocarbon indicators), a computing system can generate a snippet so that the snippet includes the hydrocarbon indicators.

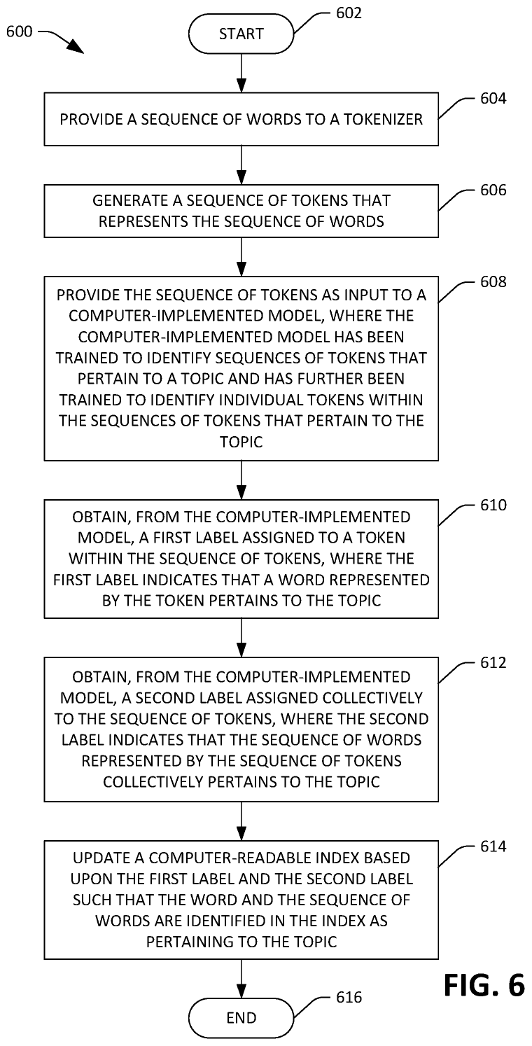

FIGS. 6-8 illustrate methodologies relating to text classification. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now solely to FIG. 6, a flow diagram illustrating a methodology 600 for updating a computer-implemented index is illustrated. The methodology 600 starts at 602, and at 604 a sequence of words is provided to a tokenizer. The sequence of words may be a paragraph, a sentence, or a phrase. At 606, a sequence of tokens is generated, where the sequence of tokens represents the sequence of words. Any suitable tokenization technologies can be employed to generate the sequence of tokens based upon the sequence of words.

At 608, the sequence of tokens is provided as input to a computer-implemented model. The computer-implemented model has been trained to identify sequences of tokens that pertain to a topic. The computer-implemented model has also been trained to identify individual tokens that pertain to the topic, where the individual tokens are included in the sequence of tokens. The computer-implemented model has been trained to concurrently identify: 1) the sequences of tokens that pertain to the topic; and 2) the individual tokens that pertain to the topic.

At 610, a first label assigned to a token within the sequence of tokens is obtained, where the first label indicates that a word or subword represented by the token pertains to the topic. At 612, a second label is obtained from the computer-implemented model, where the second label is assigned to the sequence of tokens. The second label indicates that the sequence of words represented by the sequence of tokens collectively pertains to the topic. For example, the second label can indicate that the sequence of words includes at least one word that pertains to the topic.

At 614, a computer-readable index is updated based upon the first label and the second label such that the word and the sequence of words are identified in the index as pertaining to the topic. The methodology 600 completes at 616.

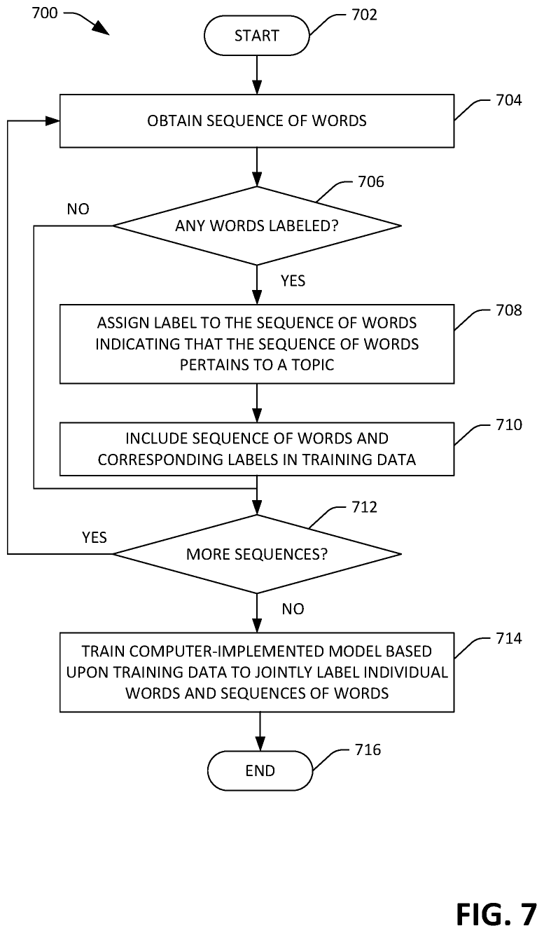

Referring now to FIG. 7, a flow diagram illustrating a methodology 700 for training a computer-implemented model to concurrently identify: 1) individual words in sequences of words that pertain to a topic; and 2) sequences of words that pertain to the topic is presented. The methodology 700 starts at 702, and at 704 a sequence of words from labeled data is obtained. At 706, a determination is made as to whether any words in the sequence of words are labeled as pertaining to a topic with respect to which the computer-implemented model is to be trained. When it is determined at 706 that at least one word in the sequence of words is labeled as pertaining to the topic, the methodology 700 proceeds to 708, where a label is assigned to the sequence of words. The label indicates that the sequence of words pertains to the topic. At 710, the sequence of words and corresponding labels are included in training data.

When it is determined at 706 that there are no words in the sequence of words that are labeled as pertaining to the topic or upon the sequence of words and corresponding labels being included in the training data at 710, a determination is made at 712 as to whether the labeled data includes additional sequences of words. When the labeled data includes additional sequences of words, the methodology 700 returns to 704, where another sequence of words is obtained. When it is determined at 712 that there are no further sequences of words in the labeled data, the methodology 700 proceeds to 714, where the computer-implemented model is trained based upon the training data such that the computer-implemented model, when trained, can concurrently label individual words and sequences of words as pertaining to the topic upon provision of the sequences of words as input to the computer-implemented model. The methodology completes at 716.

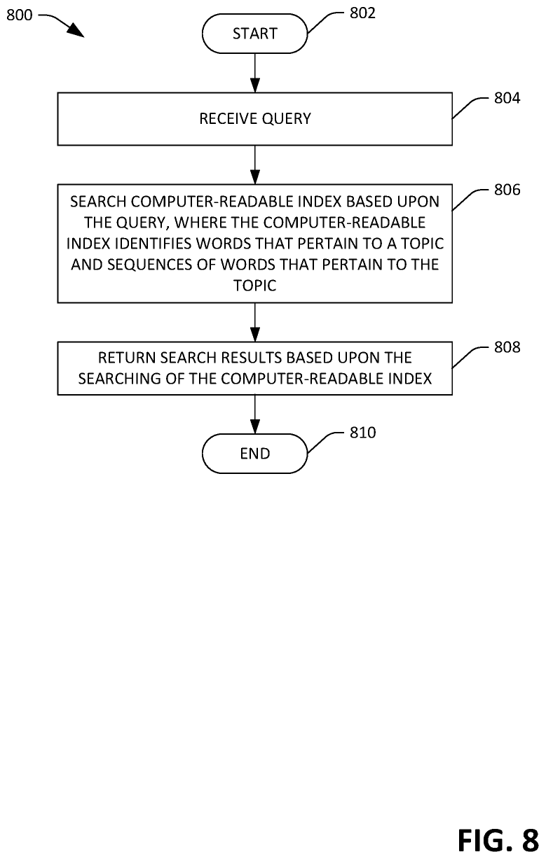

Turning now to FIG. 8, a flow diagram illustrating a methodology 800 for identifying and ranking search results based upon a query is illustrated. The methodology 800 starts at 802, and at 804 a query is received. The query can be set forth by a user of a client computing device who is attempting to identify words, sequences of words, and/or documents that pertain to a topic of interest.

At 806, a computer-readable index is searched based upon the query, where the computer-readable index indexes words, sequences of words, and/or documents by a topic. Put differently, in the computer-readable index, the words, sequences of words, and/or documents are assigned a label that indicates that the words, sequences of words, and/or documents pertain to the topic. As described previously, a computer-implemented model can output the labels for the words, sequences of words, and/or documents, where the computer-implemented model concurrently assigns a first label to a sequence of words and a second label to a word in the sequence of words. The first label indicates whether or not the sequence of words collectively pertains to the topic while the first label indicates whether or not the word in the sequence of words pertains to the topic.

At 808, search results are returned to an issuer of the query based upon the searching of the computer-readable index. As described previously, a search result can be a word, a sequence of words, and/or a document and can be ranked within a ranked list of search results based upon one or more labels assigned thereto. The methodology 800 completes at 810.

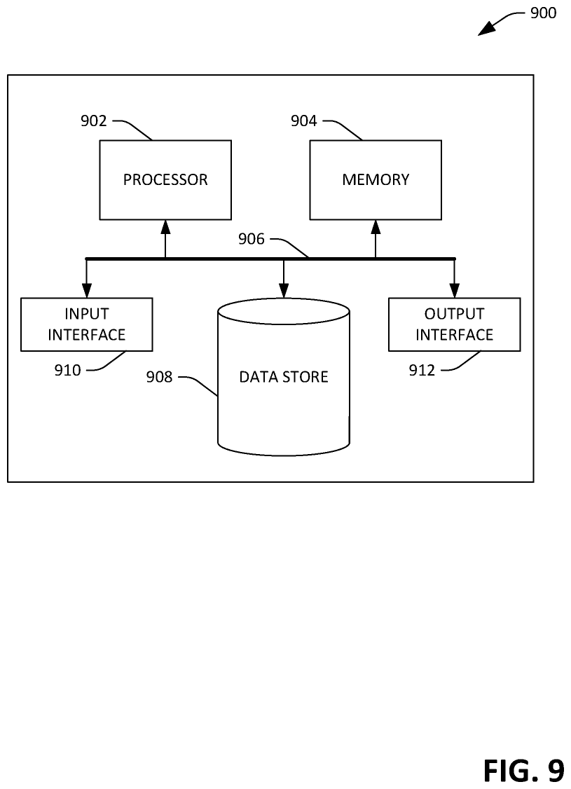

Referring now to FIG. 9, a high-level illustration of an exemplary computing device 900 that can be used in accordance with the systems and methodologies disclosed herein is illustrated. For instance, the computing device 900 may be used in a system that performs text classification. By way of another example, the computing device 900 can be used in a system that trains computer-implemented models. In yet another example, the computing device 900 can be used in a system that searches over a computer-readable index. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store unstructured text, labels assigned to words and/or sequences of words in the unstructured text, etc.

The computing device 900 additionally includes a data store 908 that is accessible by the processor 902 by way of the system bus 906. The data store 908 may include executable instructions, labels, training data, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Features have been described herein in accordance with at least the following examples.

(A1) In accordance with an aspect, in some embodiments a method described herein includes providing tokens as input to a computer-implemented model, where the tokens are representative of a sequence of words, and further where the computer-implemented model has been trained to identify sets of tokens that pertain to a topic and individual tokens within the sets of tokens that pertain to the topic. The method also includes obtaining, from the computer-implemented model: 1) a first label assigned to a token within the tokens by the computer-implemented model, where the first label indicates that a word represented by the token pertains to the topic; and 2) a second label assigned collectively to the tokens by the computer-implemented model, where the second label indicates that the sequence of words represented by the tokens collectively pertains to the topic. The method additionally includes updating a computer-implemented index based upon the first label and the second label such that the word and the sequence of words are identified in the computer-implemented index as pertaining to the topic.

(A2) In some embodiments of the method of (A1), the method also includes obtaining the sequence of words and generating the set of tokens based upon the sequence of words.

(A3) In some embodiments of the method of at least one of (A1)-(A2), the method further includes extracting text from an electronic document and identifying boundaries of a sentence in the text, where the sentence is the sequence of words.

(A4) In some embodiments of the method of at least one of (A1)-(A3), the computer-implemented model is a binary classifier.

(A5) In some embodiments of the method of at least one of (A1)-(A4), the first label indicates that the word belongs to a predefined category and the second label indicates that the sequence of words includes at least one word that belongs to the predefined category.

(A6) In some embodiments of the method of at least one of (A1)-(A5), the first label indicates that the word represents a hydrocarbon indicator and the second label indicates that the sequence of words comprises a hydrocarbon indicator.

(A7) In some embodiments of the method of at least one of (A1)-(A6), the method also includes receiving a query subsequent to updating the computer-implemented index, where the query identifies the topic. The method further includes returning at least one of the word or the sequence of words based upon the query.

(A8) In some embodiments of the method of at least one of (A1)-(A7), the computer-implemented model is a deep neural network that comprises bidirectional transformer encoders.

(A9) In some embodiments of the method of at least one of (A1)-(A8), the sequence of words is a paragraph that includes a sentence. The method also includes obtaining, from the computer-implemented model, a third label assigned to a subset of the tokens that represents the sentence in the paragraph, where the third label indicates that the sentence represented by the subset of the tokens pertains to the topic.

(A10) In some embodiments of the method of at least one of (A1)-(A9), the method also includes obtaining training data, where the training data comprises a second sequence of words, and further where a second word in the second sequence of words has a third label assigned thereto that indicates that the second word pertains to the topic. The method additionally includes updating the training data to include a fourth label that is assigned to the second sequence of words, where the fourth label indicates that the second sequence of words pertains to the topic, and further where the training data is updated based upon the third label being assigned to the second word. The method further includes training the computer-implemented model based upon the training data such that the computer-implemented model is configured to jointly identify: 1) words that pertain to the topic; and 2) sequences of words that pertain to the topic. The computer-implemented model is trained subsequent to updating the training data.

(B1) In another aspect, in some embodiments a method performed by a computer system includes providing a sequence of tokens as input to a computer-implemented deep neural network, where the sequence of tokens is representative of a sentence extracted from text of an electronic document, and further where the computer-implemented deep neural network has been trained to concurrently identify individual words that pertain to a topic and sentences that pertain to the topic. The method also includes obtaining from the computer-implemented deep neural network: 1) a first label for a token in the sequence of tokens, where the first label indicates that a word represented by the token pertains to the topic; and 2) a second label for the sequence of tokens, wherein the second label indicates that the sentence pertains to the topic. The method additionally includes mapping, in a computer-implemented database, the word to the topic based upon at least one of the first label or the second label.

(B2) In some embodiments of the method of (B1), the method also includes mapping the sentence to the topic based upon the second label.

(B3) In some embodiments of the method of at least one of (B1)-(B2), the first label indicates that the word represented by the token belongs to a category, and further wherein the second label indicates that the sentence includes the word that belongs to the category.

(B4) In some embodiments of the method of at least one of (B1)-(B3), the first label indicates that the word represented by the token is at least a portion of a hydrocarbon indicator, and the second label indicates that the sentence includes the hydrocarbon indicator.

(B5) In some embodiments of the method of at least one of (B1)-(B4), the sentence belongs to a paragraph extracted from the text of the electronic document. The method also includes providing a super sequence of tokens as input to the computer-implemented neural network, where the super sequence of tokens includes the sequence of tokens. The method further includes obtaining a third label for the super sequence of tokens from the computer-implemented neural network, where the third label indicates that the paragraph pertains to the topic.

(B6) In some embodiments of the method of at least one of (B1)-(B5), the computer-implemented deep neural network is a language transformer model.

(B7) In some embodiments of the method of at least one of (B1)-(B6), the method also includes receiving a query from a client computing device that is in network communication with the computing system, wherein the query identifies the topic. The method further includes identifying the word in the database based upon the query identifying the topic. The method additionally includes returning the word to the client computing device upon identifying the word.

(C1) In yet another aspect, some embodiments include a computing system that includes a processor and memory, where the memory stores instructions that, when executed by the processor, cause the processor to perform any of the methods disclosed herein (e.g., any of (A1)-(A10) or (B1)-(B7)).

(D1) In still yet another aspect, some embodiments include a computer-readable storage medium that includes instructions that, when executed by a processor, cause the processor to perform any of the methods disclosed herein (e.g., any of (A1)-(A10) or (B1)-(B7)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
providing tokens as input to a computer-implemented model, wherein the tokens are representative of a sequence of words, and further wherein the computer-implemented model has been trained to identify sets of tokens that pertain to a topic and individual tokens within the sets of tokens that pertain to the topic;
obtaining, from the computer-implemented model:
a first label assigned to a token within the tokens by the computer-implemented model, wherein the first label indicates that a word represented by the token pertains to the topic; and
a second label assigned collectively to the tokens by the computer-implemented model, wherein the second label indicates that the sequence of words represented by the tokens collectively pertains to the topic; and
updating a computer-implemented index based upon the first label and the second label such that the word and the sequence of words are identified in the computer-implemented index as pertaining to the topic.

2. The computing system of claim 1, the acts further comprising:
obtaining the sequence of words; and
generating the set of tokens based upon the sequence of words.

3. The computing system of claim 2, the acts further comprising:
extracting text from an electronic document;
identifying boundaries of a sentence in the text, wherein the sentence is the sequence of words.

4. The computing system of claim 1, wherein the computer-implemented model is a binary classifier.

5. The computing system of claim 1, wherein the first label indicates that the word belongs to a predefined category and wherein the second label indicates that the sequence of words includes at least one word that belongs to the predefined category.

6. The computing system of claim 1, wherein the first label indicates that the word represents a hydrocarbon indicator and the second label indicates that the sequence of words comprises a hydrocarbon indicator.

7. The computing system of claim 1, the acts further comprising:
subsequent to updating the computer-implemented index, receiving a query, wherein the query identifies the topic; and
returning at least one of the word or the sequence of words based upon the query.

8. The computing system of claim 1, wherein the computer-implemented model is a deep neural network that comprises bidirectional transformer encoders.

9. The computing system of claim 1, wherein the sequence of words is a paragraph that includes a sentence, the acts further comprising:
obtaining, from the computer-implemented model, a third label assigned to a subset of the tokens that represents the sentence in the paragraph, wherein the third label indicates that the sentence represented by the subset of the tokens pertains to the topic.

10. The computing system of claim 1, the acts further comprising:
obtaining training data, wherein the training data comprises a second sequence of words, and further wherein a second word in the second sequence of words has a third label assigned thereto that indicates that the second word pertains to the topic;
based upon the third label being assigned to the second word, updating the training data to include a fourth label that is assigned to the second sequence of words, wherein the fourth label indicates that the second sequence of words pertains to the topic; and
subsequent to updating the training data, training the computer-implemented model based upon the training data such that the computer-implemented model is configured to jointly identify:
words that pertain to the topic; and
sequences of words that pertain to the topic.

11. A method performed by a computing system, the method comprising:
providing a sequence of tokens as input to a computer-implemented deep neural network, wherein the sequence of tokens is representative of a sentence extracted from text of an electronic document, and further wherein the computer-implemented deep neural network has been trained to concurrently identify individual words that pertain to a topic and sentences that pertain to the topic;
obtaining from the computer-implemented deep neural network:
a first label for a token in the sequence of tokens, wherein the first label indicates that a word represented by the token pertains to the topic; and
a second label for the sequence of tokens, wherein the second label indicates that the sentence pertains to the topic; and
in a computer-implemented database, mapping the word to the topic based upon at least one of the first label or the second label.

12. The method of claim 11, further comprising mapping the sentence to the topic based upon the second label.

13. The method of claim 11, wherein the first label indicates that the word represented by the token belongs to a category, and further wherein the second label indicates that the sentence includes the word that belongs to the category.

14. The method of claim 13, wherein the first label indicates that the word represented by the token is at least a portion of a hydrocarbon indicator, and further wherein the second label indicates that the sentence includes the hydrocarbon indicator.

15. The method of claim 11, wherein the sentence belongs to a paragraph extracted from the text of the electronic document, the method further comprising:
providing a super sequence of tokens as input to the computer-implemented neural network, wherein the super sequence of tokens includes the sequence of tokens; and
obtaining a third label for the super sequence of tokens from the computer-implemented neural network, wherein the third label indicates that the paragraph pertains to the topic.

16. The method of claim 11, wherein the computer-implemented deep neural network is a language transformer model.

17. The method of claim 11, further comprising:
receiving a query from a client computing device that is in network communication with the computing system, wherein the query identifies the topic;
identifying the word in the database based upon the query identifying the topic; and
returning the word to the client computing device upon identifying the word.

18. A computer-readable storage medium comprising instructions that, when executed by a processor, cause the processor to perform acts comprising:
providing tokens as input to a computer-implemented model, wherein the tokens are representative of a sequence of words, and further wherein the computer-implemented model has been trained to identify sets of tokens that pertain to a topic and individual tokens within the sets of tokens that pertain to the topic;
obtaining, from the computer-implemented model:
a first label assigned to a token within the tokens by the computer-implemented model, wherein the first label indicates that a word represented by the token pertains to the topic; and
a second label assigned collectively to the tokens by the computer-implemented model, wherein the second label indicates that the sequence of words represented by the tokens collectively pertains to the topic; and
updating a computer-implemented index based upon the first label and the second label such that the word and the sequence of words are identified in the computer-implemented index as pertaining to the topic.

19. The computer-readable storage medium of claim 18, wherein the sequence of words is a paragraph extracted from a webpage.

20. The computer-readable storage medium of claim 17, wherein the first label indicates that the word represented by the token is at least a portion of a hydrocarbon indicator and the second label indicates that the sequence of words includes the hydrocarbon indicator.
